(19) United States
(12) Patent Application Publication
(10) Pub. No.: US 2002/0131717 A1
(43) Pub. Date: Sep. 19, 2002

(54) Precision optical centering device and method

(76) Inventor: Joseph S. Kovalchick, Germansville, PA (US)

Correspondence Address: VOLENTINE FRANCOS, PLLC, 12200 SUNRISE VALLEY DRIVE, SUITE 150, RESTON, VA, 20191, US

(21) Appl. No.: 09/943,081

(22) Filed: Aug. 31, 2001

Related U.S. Application Data
(60) Provisional application No. 60/276,131, filed on Mar. 16, 2001.

(51) Int. Cl. G02B 6/26

(52) U.S. Cl. 385/52; 385/39

(57) ABSTRACT

A precision optical centering device for a passive optical element includes a first feature on a substrate which secures and centers the passive optical element in the alignment device and a second feature on the substrate which is adapted to mate the substrate to another separate substrate having another optical element to which the passive optical element is to be coupled. The first feature aligns the passive optical element to the other optical element along the y-axis when the substrates are mated. The position of the passive optical element may be altered along the x-axis and/or the z-axis before the device is secured to the separate substrate. The device may be actively or passively aligned.

### CROSS REFERENCE TO RELATED APPLICATIONS

The present application claims priority under 35 U.S.C. §119(e) to U.S. Provisional Application No. 60/276,131 entitled “Precision Optical Centering Device” filed Mar. 16, 2001, which is hereby incorporated by reference in its entirety for all purposes.

### FIELD OF THE INVENTION

The present invention relates generally to optical interconnects, and particularly to a device and method to align the optic axes of optical elements.

### BACKGROUND OF THE INVENTION

Typically coupling between optical components has involved stack up or vertical arrangements. Stack up arrangements involve complicated assembly processes using multiple pieces, active alignments, and/or compromised optical performance. Solutions involving v-grooves for providing alignment typically require providing a v-groove in a substrate housing the optical element with which the optical element in the v-groove is to be coupled. This requires very high precision manufacturing for the depth and position of the v-groove, which must be assumed to work for a predetermined size of an optical element to be received therein.

### SUMMARY OF THE INVENTION

The present invention relates to an optical centering device and method which overcomes at least one of the above disadvantages.

It is an object of the present invention to provide a structure for aligning optical elements in a manner which reduces stack-up tolerances.

To achieve the above and other objects, an alignment block includes a holding section which holds an optical element at a substantially precise position. The alignment block is located in a manner in which the holding section is substantially aligned to another optical device.

By virtue of the present invention, precise alignment of the optical device held in the holding section to the other optical device is facilitated.

At least one of the above and other objects of the present invention may be realized by providing an alignment device for a passive optical element including a first feature on a substrate which secures the passive optical element in the alignment device and a second feature on the substrate which is adapted to mate the substrate to another separate substrate having another optical element to which the passive optical element is to be coupled. When the substrate is mated with the another substrate, the first feature aligns the passive optical element to the another optical element along a first axis and the second feature is attached to the another substrate to align the passive optical element to the another optical element along a second axis, different from the first axis.

At least one of the above and other objects of the present invention may be realized by providing a method for aligning optical elements on separate substrates, the method including securing a passive optical element in a first feature on a first substrate, aligning the first substrate to a second substrate having an optical element thereon, the first feature aligning the passive optical element with the optical element along a first axis and positioning the first substrate relative to the second substrates along a second axis, different from the first axis, and attaching aligned first and second substrates via a second feature of the first substrate to provide optical coupling between the passive optical element and the optical element.

The securing of the passive optical element in the first feature may include providing the passive optical element in a groove in the first substrate, the groove serving as the first feature. The groove may be a V-groove. The mounting may include an arm in the first substrate extending, either laterally and/or longitudinally, over the second substrate when the first and second substrates are mated, the arm serving as the second feature. The securing of the passive optical element may occur before or after the securing of the aligned first and second substrates. The passive optical element may be removed after the attaching of the aligned first and second substrates. The position of the passive optical element along a third axis, different from the first and second axes, after the securing and the attaching

These and other objects of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1(a) is a perspective front view of an alignment block according to an illustrative embodiment of the present invention.

FIG. 1(b) is a perspective rear view of an alignment block according to an illustrative embodiment of the present invention.

FIG. 2(a) is a perspective rear view of an aligmnent block according to another illustrative embodiment of the present invention.

FIG. 2(b) is a magnified view of an alignment block according to an illustrative embodiment shown in FIG. 2(a).

FIG. 2(c) is a perspective front view of an alignment block according to an illustrative embodiment of the present invention.

FIG. 2(d) is a magnified view of an alignment block according to an illustrative embodiment shown in FIG. 2(c).

FIG. 3 is a front view of an alignment block according to an illustrative embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

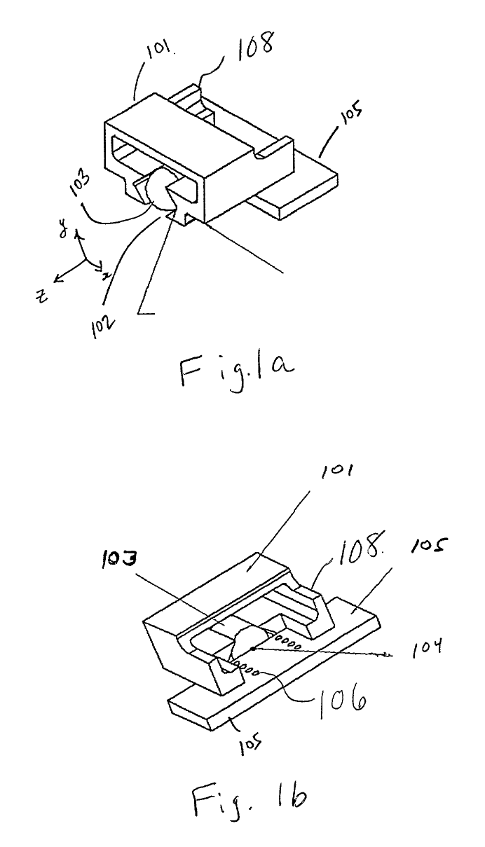

Turning to FIGS. 1(a) and 1(b), the alignment block 101 is shown. A holding section 102 is shown having a substantially precisely located passive optical element 103. The alignment block 101 also includes a mating section 108 which mates the alignment block 101 to another substrate having an optical element thereon. In FIGS. 1(a) and 1(b), the mating section 108 includes two arms which extend longitudinally from the alignment block 101.

In the illustrative embodiment of FIGS. 1(a) and 1(b), the passive optical element 103 is a lens element. This lens element could be a spherical lens, a gradient refractive index (GRIN) lens, or other lens element well within the purview of one having ordinary skill in the art. Although not shown in FIGS. 1(a) and 1(b), this passive optical element 103 could also be an optical fiber. The alignment block 101 provides accurate registration of the optical axis of the optical element 103. To this end, in the illustrative embodiment shown in FIG. 1(a), the optical axis of the passive optical element 103 would be along the z-direction. As would be readily apparent to one having ordinary skill in the art, it is important to assure that the x-y registration, again see FIG. 1(a), of the optical element is precisely located, as well. Accordingly, the holding section 102 is designed such that precise placement/alignment of the passive optical element 103 is fostered. This placement enables coupling of the passive optical element 103 to another optical element, for example an active optical element 104 shown in FIGS. 1(a) and 1(b).

In the illustrative embodiment shown in FIGS. 1(a) and 1(b), a submount 105 may be an optical subassembly or other type of optical bench or substrate. The submount 105 may include an active optical device 104, illustratively a laser or light emitting diode (LED), or other active device including an optical detector. If an active optical device 104 is provided on the submount 105, the submount 105 may include contact pads 106 to provide electrical connection to the active optical device 104. Moreover, the submount 105 may include other passive optical devices. In either case, the passive optical element 103 may be precisely aligned to various optical elements on the submount 105.

The holding section 102 of the alignment block 101 provides centering. The alignment block 101 could be fabricated via a number of well known technique such that the holding section, which resembles “V”-shape is precisely located to a mounting surface. Illustratively, the mounting surface is the submount 105. In the illustrative embodiment shown in FIGS. 1(a) and 1(b), the “V”-shaped holding section 102 is slightly undersized to provide a clamping or friction force on the passive optical element 103.

The provision of the passive optical element 103 in the alignment block 101 separate from the submount 105 allows the relative positioning of the alignment block 101 and the optical element 104 on the submount 105. In particular, the holding section 102, in conjunction with the mating section 108, positions the passive optical element 103 in the Y-direction. Before the alignment block 101 is secured to the submount 105, but while mated to the submount 105, the alignment block 101 may be moved along the X-axis and/or the Z-axis to more precisely align the optical elements 103, 104. This alignment may be active, i.e., while the active optical element 104 is on, or passive. If passive alignment is employed, the contact pads 106 may be used as passive alignment features. Of course, other passive alignment features may be provided on the submount 105 as needed.

During alignment, the alignment block 101 may be held by some tooling attached to the alignment system, e.g., a robot or translational stages. This holding may be realized using a vacuum or a mechanical clamp. Any conventional attachment manner may be used to attach the alignment block 101 to the submount 105. For example, epoxy or other bonding material may be used. Additionally, the submount 105 and the alignment block 101 could be metalized and then soldered together. The alignment block 101 may be made of a material having a coeffecient thermal expansion which matches that of the submount 105 for performance reliability. The alignment block 101 may be made of a mechanically stable material, so that the alignment block 101 does not change shape over time, thus affecting the coupling.

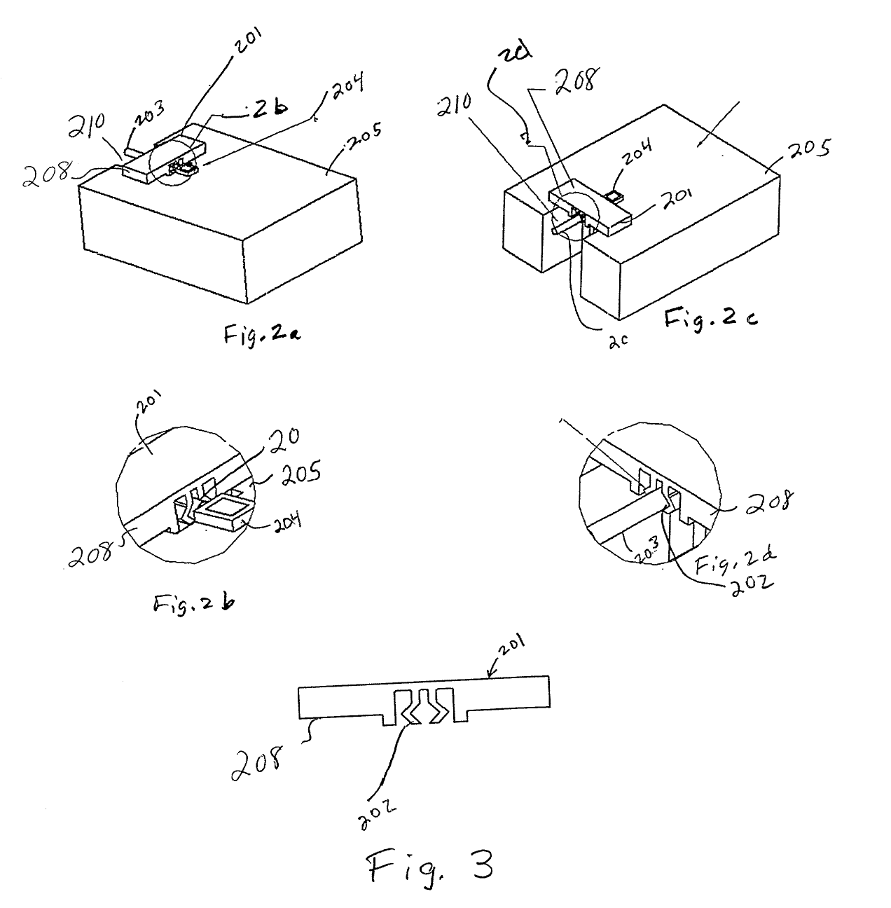

Turning to FIG. 2(a), another illustrative embodiment of the present invention is shown. In the illustrative embodiment shown in FIG. 2(a), an alignment structure 201 is mounted to a surface of a substrate 205. The substrate 205 may include an active optical device 204, e.g., a laser or a detector. In the illustrative embodiment in which the active optical device 204 is coupled to a passive optical device 203, such as an optical fiber, the active optical device 204 is disposed over the substrate 205 such that its active area is substantially in the same plane as the top surface of the substrate 205.

Shown in magnified view in FIG. 2(b), the alignment structure 201 includes a holding section 202 which holds a passive optical device 203 in the alignment structure 201 and a mating section 208 which mates the alignment structure 201 to the substrate 205. In FIGS. 2(a)-2(d), the passive optical element 203 is illustratively an optical fiber. The optical fiber 203 is optically coupled to an active optical device 204, illustratively a laser. Of course, the illustrative embodiment of FIGS. 2(a) and 2(b) could be used to facilitate alignment of a passive optical element 203 to other devices. Illustratively, other devices could include active devices such as light emitting devices, as well as detecting devices. Moreover, the alignment structure 201 could be used to precisely align passive optical elements (not shown) disposed on the substrate 205 to other passive optical elements, such as optical fiber 203.

Turning to FIG. 2(c), a perspective front view according to an illustrative embodiment of the present invention is shown. The optical fiber 203 is passively aligned in the alignment structure 201. Again, the active optical device 204 is disposed over a substrate 205. Shown in a magnified view in FIG. 2(d), the optical fiber 203 is precisely aligned and held in holding section 202. The holding section 202 constrains the fibers 203 such that the only the z-axis of the fiber can be adjusted once the alignment structure 201 is attached to the substrate 205. This embodiment of the invention could be used as a fiber receptacle. Once the alignment structure 201 is aligned to the active optical device 204, a fiber could be inserted or removed until ultimately required. The alignment of the alignment structure 201 to the active optical device 204 in the passive alignment case may use machine vision. The V's of the holding section 202 or additional features on the top 201 may be used to determine the x-axis position, where the x-axis is orthogonal to fiber axis and parallel to the top of 205. Further, passive alignment features may be provided on the top of the submount 205 and/or in a face of a notch 210 in the submount 205 to facilitate passive alignment. If active alignment is used, a fiber may be provided in the holding section 202 during x-axis alignment.

As can be seen in FIGS. 2(a) and 2(c), the submount 205 provides further structural support to the alignment structure 201. In FIGS. 2(a)-2(d), the mating section 208 includes arms laterally extending from the alignment structure 201, so placement of the alignment structure 201 effectively mounts the alignment structure 201 on the substrate 205. However, the notch 210 in the substrate 206 allows the alignment structure 201 to be moved in the X-direction and/or Z-direction prior to securing the alignment structure 201 to the submount 205. The securing of the alignment block 201 to the submount 205 may be realized in any of the manners noted above regarding the first embodiment.

Finally, turning to FIG. 3, a front view of the alignment block 201 according to an illustrative embodiment of the present invention is shown. The alignment block includes a holding section 202 which precisely aligns an passive optical device (not shown in FIG. 3) to another optical device. As described briefly above, the alignment block 201 precisely centers and aligns the optic axis of the passive optical component to the optic axis another optical device, such as the active optical device 204.

In both of these configurations, the passive optical element may either be secured in an alignment device, and then this alignment device is secured to a separate submount having another optical element thereon, or the alignment device may be aligned and attached to the submount and the passive optical element inserted thereafter. Further, either configuration could align any desired passive optical element if appropriately formed. If the passive optical element has an elongated shape, i.e., extends beyond the clamping section of the alignment structure, such as a GRIN or a fiber, z-axis alignment may be altered even after the alignment structure has been secured to the submount.

The securing section as shown in all of the embodiments is a pair of facing opposed V-grooves. This configuration allows optical elements of different sizes to be centered in the securing section, obviously as long as the optical element can be accommodated in the securing section. While the provision of an optical element in the securing section having a smaller diameter than the optical element for which the securing section was designed will not be as precisely centered as the designed for element, for many applications this centering is sufficient and increases the application flexibility of the alignment device. Any configuration which allows centering of differently sized optical elements, particularly those allowing optical elements to be removed and inserted from a secured alignment device, may be employed. For example, a number of differently shaped grooves may be employed, the opposing grooves do not need to have the same shape, and there may only be one groove opposite a flat surface.

It will be obvious that the invention may be varied in a plurality of ways. For example, the alignment slot does not have to be through the substrate, but may extend underneath the passive optical element to provide support thereto. Such variations are not to be regarded as a departure from the scope of the invention. All such modifications as would be obvious to one skilled in the art are intended to be included within the scope of the appended claims.

What is claimed is:

1. An alignment device for a passive optical element comprising:
a first feature on a substrate which secures the passive optical element in the alignment device; and
a second feature on the substrate which is adapted to mate the substrate to another separate substrate having another optical element to which the passive optical element is to be coupled, wherein, when the substrate is mated with the another substrate, the first feature aligns the passive optical element to the another optical element along a first axis and the second feature is attached to the another substrate to align the passive optical element to the another optical element along a second axis, different from the first axis.

2. The alignment device of claim 1, wherein the passive optical element is a lens element.

3. The alignment device of claim 1, wherein the passive optical element is a waveguide.

4. The alignment device of claim 1, wherein the first feature is a pair of opposing grooves in the substrate which receives the passive optical element.

5. The alignment device of claim 4, wherein the grooves are V-grooves.

6. The alignment device of claim 1, wherein the second feature is an arm extending over the another separate substrate when the substrate and the another separate substrate are mated.

7. The alignment device of claim 1, wherein said first feature allows the passive optical element to be removed and inserted after the substrate has been attached to the another substrate.

8. The alignment device of claim 1, wherein the first feature may be used to align differently sized passive optical elements along the first axis.

9. The alignment device of claim 1, wherein the passive optical element may be adjusted in the first feature along a third axis, different from said first and second axes, after the substrate has been attached to the another substrate.

10. A system for aligning optical elements on separate substrates, the system comprising:
a passive optical element;
a first substrate having an optical element thereon, said passive optical element and the optical element to be optically coupled; and
an alignment device for the passive optical element comprising
a first feature on a second substrate which secures the passive optical element in the alignment device, and
a second feature on the second substrate which is adapted to mate the second substrate to the first separate substrate, wherein, when the first and second substrates are mated, the first feature aligns the passive optical element to the another optical element along a first axis and the second feature is attached to the first substrate to align the passive optical element to the optical element along a second axis, different from the first axis

11. The system of claim 10, wherein the passive optical element is a lens element.

12. The system of claim 10, wherein the passive optical element is a waveguide.

13. The system of claim 10, wherein the first feature is a groove in the second substrate.

14. The system of claim 13, wherein the groove is a V-groove.

15. The system of claim 10, wherein the second feature is an arm extending over the first substrate when the first and second substrates are aligned.

16. The system of claim 15, wherein said arm extends laterally from the alignment device.

17. The system of claim 15, wherein said arm extends longitudinally from the alignment device.

18. The system of claim 10, wherein the optical element is an active optical element.

19. The system of claim 10, wherein the first feature allows the passive optical element to be removed and inserted after the first and second substrates have been attached.

20. The system of claim 10, wherein the first feature may be used to align differently sized passive optical elements along the first axis.

21. The system of claim 10, wherein the passive optical element may be adjusted in the first feature along a third axis, different from said first and second axes, after the first and second substrates have been attached.

22. The system of claim 10, wherein the first feature is a pair of opposing V-grooves.

23. A method for aligning optical elements on separate substrates, the method comprising:
securing a passive optical element in a first feature on a first substrate;
aligning the first substrate to a second substrate having an optical element thereon, the first feature aligning the passive optical element with the optical element along a first axis and positioning the first substrate relative to the second substrates along a second axis, different from the first axis; and
attaching aligned first and second substrates via a second feature of the first substrate to provide optical coupling between the passive optical element and the optical element.

24. The method of claim 23, wherein said securing the passive optical element in the first feature includes providing the passive optical element in a pair of opposing grooves in the first substrate.

25. The method of claim 23, wherein said securing of the passive optical element occurs after said attaching of the aligned first and second substrates.

26. The method of claim 23, further comprising removing the passive optical element after said attaching of the aligned first and second substrates.

27. The method of claim 23, further comprising adjusting a position of the passive optical element along a third axis, different from said first and second axes, after said securing and said attaching.
